(19) United States
(12) Patent Application Publication
(10) Pub. No.: US 2025/0367911 A1
(43) Pub. Date: Dec. 4, 2025

(54) GROUT FREE FIBER ENHANCED COMPOSITE LINER STEEL TUBE FOR CCUS AND WATER INJECTION

(71) Applicants: CNPC USA CORPORATION, Houston, TX (US); BEIJING HUAMEI, INC., Beijing (CN); CHINA NATIONAL PETROLEUM CORPORATION, Beijing (CN)

(72) Inventors: Lei ZHAO, Houston, TX (US); Timothy DUNNE, Pearland, TX (US); Jiaxiang (Jason) REN, Houston, TX (US); Peng CHENG, Houston, TX (US); Jiaying LI, Beijing (CN); Wenhong LI, Beijing (CN)

(21) Appl. No.: 18/680,313

(22) Filed: May 31, 2024

(51) Int. Cl. B32B 15/14; B32B 5/02; B32B 15/18; B32B 37/24; F16L 9/14

(52) U.S. Cl. CPC B32B 15/14; B32B 5/02; B32B 15/18; B32B 37/24; F16L 9/14; B32B 2037/243; B32B 2255/06; B32B 2255/205; B32B 2255/26; B32B 2260/021; B32B 2260/046; B32B 2262/101; B32B 2307/714; B32B 2307/7376; B32B 2311/30; B32B 2315/085; B32B 2363/00; B32B 2597/00

(57) ABSTRACT

A composite liner inside a steel tube comprises a glass-reinforced epoxy resin system and an anti-corrosion coating or plating on an inner diameter of the steel tubes. The glass-reinforced epoxy resin may form the composite liner attached to the inner diameter of the steel tube. The anti-corrosion coating or plating on an inner diameter of the steel tubes with low gas permeability may serve as a more effective barrier than a grout layer and enhancing performance. The anti-corrosive coating or plating is sandwiched between the glass-reinforced epoxy resin system and the steel tube.

### FIELD OF THE INVENTION

The present invention relates to a downhole pipe in carbon capture utilization storage (CCUS) injection well tubing and water injection. More particularly, the present invention relates to a grout free fiber enhanced composite liner steel tube for internal corrosion prevention in carbon capture utilization storage (CCUS) injection well tubing and water injection.

### BACKGROUND

Carbon Capture and Storage (CCS) technology has garnered widespread acceptance and recognition as a potent tool in the global drive to reduce carbon emissions. It stands as a pivotal technique for achieving the objectives set forth in the Paris Agreement. One specific CCUS approach, known as CCS-EOR (Carbon Capture and Storage-Enhanced Oil Recovery), involves using CO₂ to enhance oil production and subsequently storing the captured carbon dioxide in depleted reservoirs. While this method may not be as environmentally efficient as direct CO₂ sequestration and remains technically controversial, it does generate revenue that can offset the substantial initial capital investments.

Moreover, it promotes the development of essential infrastructure, such as pipelines, which can be instrumental for future carbon sequestration projects. Consequently, CCS-EOR has gained popularity, particularly in developing countries and regions like China, as an interim measure to address carbon emissions before implementing more advanced solutions. For all CCUS projects, the high corrosiveness of CO₂ necessitates the use of costly corrosion-resistant alloys, significantly driving up project costs and impeding widespread adoption. For instance, the recently published AMPP Guide 21532-2023 recommends the use of the expensive 25Cr alloy for corrosion protection. Therefore, any innovation capable of optimizing material selection holds immense promise for enhancing the global implementation of CCUS technology.

The conventional steel tubing cannot withstand the extremely corrosive conditions encountered in such environments. To combat these challenging conditions, expensive corrosion-resistant alloys (CRAs) like super 13Cr or 25Cr have traditionally been employed.

Over time, attempts have been made to apply various coatings to the inner surface of these tubular components. However, these coatings have proven to have limited lifetime, typically lasting less than 5 years in field applications, primarily because they are thin and susceptible to damage from intervention tools such as wirelines. Additionally, thermoplastic liners, such as High-Density Polyethylene (HDPE), which have seen extensive use in pipelines and water injection wells, have also been employed in CCUS applications. Nevertheless, they are not immune to issues, as they can fail due to a collapse when rapid degassing occurs. In more detail, CO₂ gas can infiltrate the polymer liner and accumulate between the liner and the steel tubing, causing the tubing to collapse when internal pressure drops during operation.

Therefore, there is a need to have an anti-corrosion technology designed for downhole tubular components, particularly for use in injection well tubing.

These and other objectives and advantages of the present invention will become apparent from a reading of the attached specification.

### BRIEF SUMMARY OF THE INVENTION

Embodiments of the present invention include a composite liner inside a steel tube. The composite liner inside a steel tube comprises a glass-reinforced epoxy resin system and an anti-corrosion coating or plating on an inner diameter of the steel tubes. The glass-reinforced epoxy resin may form the composite liner attached to the inner diameter of the steel tube. The anti-corrosion coating or plating on an inner diameter of the steel tubes with low gas permeability may serve as a more effective barrier than a grout layer and enhancing performance. The anti-corrosive coating or plating is sandwiched between the glass-reinforced epoxy resin system and the steel tube.

Optionally in any embodiment, the polymer coating or metal plating used in the composite liner has a thickness ranging between about 2 to about 10 mills in thickness.

Optionally in any embodiment, the glass-reinforced epoxy resin system is about 2 to 4 mm thick.

Optionally in any embodiment, the plating is a metal plating, which is at least one of Ni—P or Ni—W plating system.

Optionally in any embodiment, the anti-corrosion coating comprises a polymer coating.

Optionally in any embodiment, wherein the polymer coating comprises an epoxy coating.

In another embodiment, a method of manufacturing a composite liner for a steel tube may comprise steps of coating an inner diameter (ID) of the steel tube with an anti-corrosion coating or plating; inserting a glass-reinforced epoxy composite liner into the steel tube; and curing the glass-reinforced epoxy composite liner inside the steel tube.

Optionally in any embodiment, the glass-reinforced epoxy is an uncured or under-cured.

Optionally in any embodiment, the glass-reinforced epoxy composite liner has a diameter larger than the inner diameter of the steel tube.

Optionally in any embodiment, the anti-corrosion coating or metal plating comprises a low gas permeability material.

Optionally in any embodiment, the anti-corrosion coating comprises a polymer coating.

Optionally in any embodiment, the anti-corrosion metal plating is at least one of Ni—P, or Ni—W coating.

Optionally in any embodiment, the curing stage involves precise control of curing temperature and time to cure resin within the liner to a lesser degree, retaining deformable characteristics.

Optionally in any embodiment, the glass-reinforced epoxy composite liner comprises a dual catalyst system.

Optionally in any embodiment, the dual catalyst system comprises a low temperature catalyst.

Optionally in any embodiment, the dual catalyst system comprises a high temperature catalyst.

Optionally in any embodiment, the method further comprises filament winding glass-reinforced epoxy on a mandrel.

In further embodiment, a composite liner for a steel tube may comprise a resin system directly affixed to an inner diameter of a steel tube without requiring a troublesome grout layer, thereby eliminating a need for costly and less dependable grout layers; and a thin coating or metal plating measuring between 2 to 10 mills in thickness, sandwiched between the glass-reinforced epoxy resin system and the inner diameter of the steel tube.

Optionally in any embodiment, the resin system comprises glass-reinforced epoxy.

Optionally in any embodiment, the glass-reinforced epoxy resin system is about 2 to 4 mm thick.

Optionally in any embodiment, the metal plating is at least one of Ni—P or Ni—W plating system.

Optionally in any embodiment, the thin coating comprises an epoxy coating.

### BRIEF DESCRIPTION OF DRAWINGS

FIG. 1 is a cross-sectional view of a liner, an anti-corrosive coating or plating inside a steel tube according to one exemplary embodiment.

FIG. 2 is a method of manufacturing a composite liner for a steel tube according to an exemplary embodiment.

### DETAILED DESCRIPTION OF THE INVENTION

Before the description of the embodiment, terminology, methodology, systems, and materials are described; it is to be understood that this disclosure is not limited to the particular terminologies, methodologies, systems, and materials described, as these may vary. It is also to be understood that the terminology used in the description is for the purpose of describing the particular versions of embodiments only, and is not intended to limit the scope of embodiments. For example, as used herein, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to the understood as being modified in all instances by the term “about”.

Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

As used herein, the term “about” means plus or minus 10% of the numerical value of the number with which it is being used. Therefore, about 50% means in the range of 45%-55%.

The presented invention disclosure introduces a composite liner for a steel tube to prevent carbon dioxide corrosion against the steel tubes. To address the limitations associated with traditional liners, a Glass-Reinforced Epoxy (GRE) liner has proven to be effective in CCUS injection wells. This GRE liner is a rigid structure prepared independently and subsequently inserted into the downhole tubular. The space between the GRE liner and the tubular is filled with grout materials such as cement or mortar, which solidify to create an immediate layer between the steel tube and the GRE liner.

This layer serves a dual purpose: firstly, it transfers the load from the relatively weaker GRE liner to the steel tube, enhancing the production's high-pressure rating compared to GRE tubulars. Secondly, it acts as an additional barrier layer, safeguarding the inner surface of the steel tube in case gas or moisture manages to penetrate the GRE liner. This is particularly advantageous because polymer materials, like GRE, typically have larger molecular spacing that can allow small gas molecules to diffuse through. Towards the end of the assembly, a connection seal is established at the junctions of adjacent tubing. This technology has demonstrated successful usage for over five decades, initially in water injection wells and subsequently in CCUS wells. In fact, the standard ISO 17348 for CO₂ Enhanced Oil Recovery (EOR) wells exclusively permits the use of GRE liners in addition to costly CRA materials due to its proven track record.

However, it is important to acknowledge that despite its success, this technology has some inherent drawbacks due to the rigid and brittle nature of the grout layer. Firstly, the grout layer can fracture into pieces when subjected to vibrations during operation. Additionally, the final tubular assembly cannot be bent as flexibly as ordinary steel tubing, limiting its application in deviated wellbores. Secondly, the typical use of porous materials like cement in the grout layer does not provide an effective barrier effect. Data have shown that the gas permeability of concrete is five orders of magnitude higher than that of epoxies, which are the primary constituents of GRE liners or coatings. Thirdly, the existence of grout layer reduces the ID of final product, restricting the allowable flow rate. Lastly, the grout filling process is labor-intensive and challenging to control, resulting in added costs and quality assurance/quality control (QA/QC) challenges.

The present invention presents an inventive approach for directly affixing a rigid composite liner onto the inner diameter (ID) of a steel tube, eliminating the need for costly and less dependable grout layers. Additionally, we incorporate a coating or plating design into the treatment of the tube's ID, resulting in a substantial reduction in CO₂ gas permeability. As a result, the composite liner tube is not only more flexible but also demonstrates a significantly enhanced barrier effect.

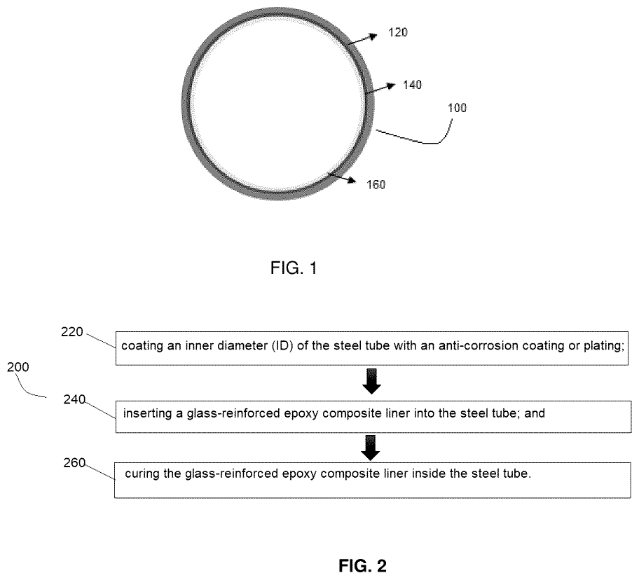

Referring to FIG. 1, a composite liner 100 inside a steel tube 120 may comprise a glass-reinforced epoxy resin system 160 and an anti-corrosion coating or plating 140 on an inner diameter of the steel tubes 120 with low gas permeability serving as a more effective barrier than a grout layer and enhancing performance. The anti- corrosive coating or plating 140 is sandwiched between the glass-reinforced epoxy resin system 160 and the steel tube 120.

In one embodiment, the anti-corrosion coating or metal plating 140 used in the composite liner has a thickness ranging between about 2 to about 10 mills, for example, in thickness. The glass-reinforced epoxy resin system is about 2 to 4 mm thick, for example.

The metal plating 140 may be at least one of Ni—P or Ni—W plating system.

### Ni—P Based Composite Coating

Electroless and electro plating of nickel-phosphorous (Ni—P) based composites as coatings for CCUS injection well disclosed herein may be formed by codeposition of inert particles onto a metal matrix from an electrolytic or electroless bath. The Ni—P composite coating provides excellent adhesion to most metal and alloy substrates. The final properties of these coatings depend on the phosphorous content of the Ni—P matrix, which determines the structure of the coatings, and on the characteristics of the embedded particles such as type, shape and size. Ni—P coatings with low phosphorus content are crystalline Ni with supersaturated P. With increasing P content, the crystalline lattice of nickel becomes more and more strained and the crystallite size decreases. At a phosphorous content greater than 12 wt %, or 13 wt %, or 14 wt % or 15 wt %, the coatings exhibit a predominately amorphous structure. Annealing of amorphous Ni—P coatings may result in the transformation of amorphous structure into an advantageous crystalline state. This crystallization may increase hardness, but deteriorate corrosion resistance. The richer the alloy in phosphorus, the slower the process of crystallization. This expands the amorphous range of the coating. The Ni—P composite coatings can Incorporate other metallic elements including, but not limited to, tungsten (W) and molybdenum (Mo) to further enhance the properties of the coatings. The nickel-phosphorous (Ni—P) based composite coating disclosed herein may include micron-sized and sub-micron sized particles. Non-limiting exemplary particles include: diamonds, nanotubes, rings (including carbon nano rings), carbides, nitrides, borides, oxides and combinations thereof. Other non-limiting exemplary particles include plastics (e.g., fluoro-polymers) and hard metals.

### Layered Materials and Novel Composite Coating Layers

Layered materials such as graphite, MoS₂ and WS₂ (platelets of the 2H polytype) may be used as coatings for oil and gas well production devices. In addition, fullerene based composite coating layers which include fullerene-like nanoparticles may also be used as coatings for CCUS injection well. Fullerene-like nanoparticles have advantageous tribological properties in comparison to typical metals while alleviating the shortcomings of conventional layered materials (e.g., graphite, MoS₂). Nearly spherical fullerenes may also behave as nanoscale ball bearings. The main favorable benefit of the hollow fullerene-like nanoparticles may be attributed to the following three effects: (a) rolling friction; (b) the fullerene nanoparticles function as spacers, which eliminate metal to metal contact between the asperities of the two mating metal surfaces; and (c) three body material transfer. Sliding/rolling of the fullerene-like nanoparticles in the interface between rubbing surfaces may be the main friction mechanism at low loads, when the shape of nanoparticle is preserved. The beneficial effect of fullerene-like nanoparticles increases with the load. Exfoliation of external sheets of fullerene-like nanoparticles was found to occur at high contact loads (˜1 GPa). The transfer of delaminated fullerene-like nanoparticles appears to be the dominant friction mechanism at severe contact conditions. The mechanical and tribological properties of fullerene-like nanoparticles can be exploited by the incorporation of these particles in binder phases of coating layers. In addition, composite coatings incorporating fullerene-like nanoparticles in a metal binder phase (e.g., Ni—P electroless plating) can provide a film with self-lubricating and excellent anti-sticking characteristics suitable for coatings for oil and gas well production devices.

More generally, other reinforcing materials could be applied in the layers. These materials include, but are not limited to, carbon nanotubes, graphene sheets, metallic particles of high aspect ratio (i.e. relatively long and thin), ring-shaped materials (e.g. carbon nanorings), and oblong particles. Typically, these particles would have dimensions on the order of a few nanometers to microns.

### Advanced Boride Based Cermets and Metal Matrix Composites

Advanced boride based cermets and metal matrix composites as coatings for CCUS injection well production devices may be formed on bulk materials due to high temperature exposure either by heat treatment or incipient heating during wear service. For instance, boride based cermets (e.g., TIB₂-metal), the surface layer is typically enriched with boron oxide (e.g., B₂O₃) which enhances lubrication performance leading to low friction coefficient.

### Quasicrystalline Materials

Quasicrystalline materials may be used as coatings for sleeved oil and gas well production devices. Quasicrystalline materials have periodic atomic structure, but do not conform to the 3-D symmetry typical of ordinary crystalline materials. Due to their crystallographic structure, most commonly icosahedral or decagonal, quasicrystalline materials with tailored chemistry exhibit unique combination of properties including low energy surfaces, attractive as a coating material for oil and gas well production devices. Quasicrystalline materials provide non-stick surface properties due to their low surface energy (˜30 mJ/m²) on stainless steel substrate in icosahedral Al—Cu—Fe chemistries. Quasicrystalline materials as coating layers for oil and gas well production devices may provide a combination of low friction coefficient (˜0.05 in scratch test with diamond indentor in dry air) with relatively high microhardness (400˜600 HV) for wear resistance. Quasicrystalline materials as coating layers for CCUS injection well production devices may also provide a low corrosion surface and the coated layer has smooth and flat surface with low surface energy for improved performance. Quasicrystalline materials may be deposited on a metal substrate by a wide range of coating technologies, including, but not limited to, thermal spraying, vapor deposition, laser cladding, weld overlaying, and electrodeposition.

In another embodiment, the anti-corrosion coating comprises a polymer coating. In one embodiment, the polymer coating comprises an epoxy coating. The epoxy resin used in the present invention may be any resin that contains free hydroxyl groups.

The epoxy resin having free hydroxyl groups adheres to the metallic surface because of the chemical bonds formed through electron sharing by groups on the substrate and the free hydroxyl groups of the epoxy resin, the curing is accompanied by polarity change.

It will be understood that the curing phenomenon of epoxy resin compositions involves chemical linking between polymer chains and that this linking (or “cross-linking”) mechanism is initiated almost immediately upon application of the epoxy resin upon a hot surface and continues as the epoxy resin composition melts, coalesces and gels.

Examples of preferred epoxy resins having free hydroxyl groups useful in the present invention are Epoxy, Phenolic Epoxy, Polyurethane Epoxy, and/or Novolac®.

### Thermoplastic Adhesive

In one embodiment, the adhesive is of the thermoplastic type and it allows a chemical bond with the epoxy of the first layer so as to obtain full adherence to the metal.

The thermoplastic adhesive used in the present invention may be anhydride modified polyolefin or acrylic acid modified polyolefin, since the epoxy resins have free hydroxyl groups anhydride or acrylic acid adhesive that can react to form very strong bonds to the epoxy. Epoxy resin combines very low permeability to oxygen with excellent adhesion to properly prepared metallic surfaces and excellent resistance to cathodic disbondment. However, it is permeable to moisture, and is easily damaged by mechanical impacts. It is therefore beneficial to cover the epoxy resin with a layer of a polymer that is highly resistant to moisture permeation and resistant to impact damage.

Polyolefin coatings are widely used to protect metal pipelines, especially oil and gas pipelines, from both corrosion and mechanical damage. Unfortunately, the actual thermoplastic internal coating or polyolefins liners are not bonded to epoxy resin. The present invention uses modified polyolefins that contain polar groups to bond to the epoxy resin layer.

It is to be understood that the term “modified polyolefin”, as used in the present invention, includes not only a polyolefin that is modified with an unsaturated carboxylic acid or an anhydride thereof, that is, a polyolefin copolymerized with the unsaturated carboxylic acid or the anhydride thereof, but also includes a blend of a polyolefin modified with the unsaturated carboxylic acid or anhydride thereof and an unmodified polyolefin.

The epoxy resin free hydroxyl-groups and the carboxylic acid dimer hydrogen bonding produces an epoxy resin-anhydride system. The gelation phase of reaction exhibits rapid initial hydroxyl-anhydride reactions.

The acid or anhydride modified polyolefins of the invention are, in most cases, acid or anhydride modified polyethylenes, polypropylenes, or combinations thereof. Most preferably the polyolefins of the invention are acid or anhydride modified polypropylenes, acid or anhydride modified polypropylene derivatives, or mixtures of these. The acid or anhydride modified polyolefin component of the invention may also be mixtures of acid or anhydride modified polyolefins with unmodified polyolefins. Preferably, if the emulsion comprises several polyolefins, most of the polyolefins have grafted thereto at least one acid or anhydride. The acids or anhydrides grafted on the polyolefins may be, in particular, ethylene-substituted carboxylic acids and/or polycarboxylic acids and/or acid anhydrides, such as, for example, maleic, acrylic, methacrylic, itaconic or citraconic acid (or anhydride). Most preferably the acid or anhydride modified polyolefins of the invention are maleic anhydride modified polypropylenes.

Examples of preferred acid or anhydride modified polyolefin dispersions useful in the present invention are maleic anhydride grafted polypropylene dispersions such as Hydrosize XM-10075, Hydrosize PP2-01, Hydrosize PPI-OI (all from Hydrosize Technologies, Inc., Raleigh, N.C.) and Michem Emulsion 91735 (available from Michelman, Inc., Cincinnati, Ohio).

### 12-Aminododecanoic Acid Lactam

Onto the layer of thermoplastic adhesive a fourth layer of plastic material

may be applied. This makes up the inner protection, which is very effective against abrasion and corrosion caused by fluids transported through steel pipes. Preferably, examples thereof include 12-Aminododecanoic acid lactam with the formula (C₁₂H₂₃NO). The lactam poly 12-aminododecanoic acid is fused plastically with the adhesive of the layer of thermoplastic material (3) and the layer of epoxy resin (2) achieving complete adhesion to the metal. The 12-Aminododecanoic acid lactam is also known as 12-Aminododecanolactam; 1-Aza-2-cyclotridecanone; 12-Aminododecanoic acid lactam; 2-Oxododecamethylenimine; Azacyclotridecan-2-one; Cyclododecalactam; Dodecalactam, Dodecanoic acid; 12-amino-, lactam; Dodecanolactam; Dodecyllactam; Laurin lactam; Laurolactam; Lauryl lactam; omega-Dodecalactam; Dodecane-12-lactam.

As shown in FIG. 2, a method 200 of manufacturing a composite liner for a steel tube comprises coating an inner diameter (ID) of the steel tube with an anti-corrosion coating or plating in step 220; inserting a glass-reinforced epoxy composite liner into the steel tube in step 240; and curing the glass-reinforced epoxy composite liner inside the steel tube in step 260.

In one embodiment, the anti-corrosion coating or metal plating comprises a low gas permeability material, such as a polymer. In one embodiment, the anti-corrosion metal plating is at least one of Ni—P, or Ni—W coating.

In one embodiment, the method 200 may further comprise filament winding glass-reinforced epoxy on a mandrel. The conventional production process for flexible pipes makes use of a thermoplastic liner onto which fibers are applied with a rotating mandrel or a thermoplastic liner as the basis mandrel (winding). Typically, the fibers go through a resin bath where they are impregnated before the fibers reaches the mandrel to form a so-called laminate. At the end of the winding process, the pipe is transported into a curing oven for a (final) heat curing, to ensure that the glass transition temperature is sufficiently high. After the final cure the liners are released, cut on the correct length, and both ends are machined for the joints necessary for connecting the pipes and possible fittings in the field. Moreover, the wall of a filament-wound epoxy pipe may be fairly damage intolerant and may require careful handling, installation, and/or use of specific back-fill materials. Damage or cracks in the fiber glass-reinforced epoxy layer can lead to small leaks or “weeping” of the pipe under pressure. Furthermore, the thermoplastic liners used therein are susceptible to collapse by permeating gases trapped in the annulus between the liner and the outer pipe if the pressure inside rapidly decreases.

The resin used may be thermosetting resin, which may be the same in each layer or a different thermosetting resin may be used. For instance, thermosetting resins with Increased elongation at break may be selected for the outer layers. For practical purposes, the resin used for the core layer preferably has a glass transition temperature exceeding 110°, preferably exceeding 120° C. With a Tg below 110° C., the pipe will be less suitable for employ as pipe for geothermal energy or district heating

Many types of thermosetting resin may be used. In one embodiment, heat curable resins are used. In another embodiment, radiation curable resins, more preferably UV curable resins or UV/heat curable resins are used. Radiation (UV) curable resins are known. These resins include alkyds, epoxy resins, acrylic resins, polyesters, vinyl esters, novolacs, phenolics, polyurethanes, polyimides, silicones, and many others. Of particular interest are epoxy resins, which have been used water-borne, or solvent-borne as varnish or coating. Epoxy resins tend to have better hardness properties (as compared to polyesters), with improved adhesion and less shrinkage. The thermosetting resin system may therefore include curable epoxy resins that are commonly used to reinforce fibers and then cured to provide a composite article useful in the composite industry. Most commercial epoxy resins are based on epichlorohydrin and bisphenol A or a derivative thereof. Preferably the radiation curable resin is a liquid. Preferably, the dynamic viscosity (ASTM D-445) at 25° C. is between 1,000 and 20,000 mPa.s, more preferably between 5,000 and 15,000 mPa.s, even more preferably between 9,000 and 12,000 mPa.s. Viscosities above the upper limit make it difficult to properly impregnate the fibers. This problem may be partially addressed by employing application temperatures above room temperature.

However, this affects the economy of the process. Viscosities below the lower limit likewise may cause problems due to dripping of the resin and hence inadequate impregnation of the fibers.

There are many suppliers of radiation curable resins, in particular radiation curable epoxy resins. Of particular interest are liquid epoxy resins sold by DOW under the registered trademark D.E.R. Moreover, the radiation curable resin should cure quickly and result in a pipe that is relatively flexible. Curing and flexibility are also affected by the photo initiator that is employed as well as by other additives. This is discussed hereafter. As indicated above, also a combination of different resin compositions may be used.

Thermosetting resins may exist both in single component and two-component formulations. Both may be used. An advantage of a two-component system (wherein part (a) is the resin and part (b) is the hardener) is a longer shelf life (the period of time which the resin can be stored without deterioration of properties). Single-component formulations may be easier to work with because they do not need to be mixed in the correct proportions before use. Solvent-free formulations are preferred, because they do not suffer from the problem of voids that may form during curing as a result of solvent evaporation. Moreover, solvent-free formulations do not require investments to handle evaporated solvents.

For a single component, the present exemplary method may involve a precise control of the curing temperature and time to cure the resin within the liner to a lesser degree, thus retaining its deformable characteristics. In one embodiment, the glass-reinforced epoxy composite liner has an outer diameter larger than the inner diameter of the steel tube. After the liner is pulled through the steel tube, it is then subjected to complete curing, either through high-temperature treatment or by extending the curing time. In this way, a resin system directly affixed to an inner diameter of a steel tube without requiring a troublesome grout layer, thereby eliminating a need for costly and less dependable grout layers.

Particularly suitable thermosetting resin systems are the dual cure or due catalyst thermosetting resins. Thus, it is known that thermoset systems employing low molecular weight resins and crosslinking agents may suffer from sagging, slumping, so- called fat edges and other problems because of the low viscosity during the curing bake. These rheology problems may be solved with a dual cure or due catalyst resin system. For instance, dual cure epoxies are used in applications that require a very quick initial handling strength, with full cure being achieved off-line or in a subsequent process when cycle time is not so critical. They are also suitable for applications that has shadowed area that cannot be cured with UV. An example of a dual cure resin system is UV15DC80 by Master Bond Inc., Tru-Bond™ DC 1000 UV by Devcon or AC A535-AT by Addison Clear Wave.

The due catalyst system comprises a low temperature catalyst and a high temperature catalyst. During the filament winding process, the low-temperature catalyst initiates the resin's curing at a lower level. This ensures that the liner maintains its shape while remaining deformable for subsequent steps. Once the soft liner is pulled into the steel tube, the high-temperature catalyst is activated to fully cure the composite liner, rendering it stronger and more rigid.

In the preferred dual cure resin system, many different epoxy resins can be used as component (a). The epoxy resins useful in the present invention may be selected from any known epoxy resin in the art; and may include conventional and commercially available epoxy resins, which may be used alone or in combinations of two or more.

The thermosetting resin system of the preferred embodiment may include at least one low viscosity epoxy resin compound as component (a) to form the epoxy matrix in a final curable formulation.

A few non-limiting embodiments of the epoxy resin useful as a compound in the curable epoxy resin formulation of the present invention may include, for example, epoxies selected from the group consisting of bisphenol-A based epoxy resins, bisphenol-F based epoxy resins, resorcinol based epoxy resins, methylolated phenol based epoxy resins, brominated and fluorinated epoxy resins, and combinations thereof. Examples of preferred embodiments for the epoxy resin include bisphenol A diglycidyl ether, tetrabromobisphenol A diglycidyl ether, bisphenol F diglycidyl ether, resorcinol diglycidyl ether, triglycidyl ethers of para-aminophenols, epoxy novolacs, divinylarene dioxides, cycloaliphatic epoxy, and mixtures thereof.

As described above, curable compositions and thermoset resins may be formed from an epoxy resin mixture, including a mixture of aromatic epoxy resins or a mixture of at least a flexibilized epoxy resin with a bisphenol-A based epoxy resin and a cycloaliphatic anhydride cross-linker. Other epoxy resins, additional cross-linkers, catalysts, toughening agents, flame retardants, and other additives may also be used in compositions disclosed herein. Each of these is described in more detail below.

### Flexibilized Epoxy Resin

Flexibilized epoxy resins useful in embodiments disclosed herein may include epoxy resins modified with glycols, such as an aliphatic epoxy modified with polypropylene glycol; epoxidized polybutadiene; epoxidized caprolactones and caprolactones, silicone resin containing epoxy functionality; and epoxy vinyl ester resins, among others. In some embodiments, flexibilized epoxy resins may include bis(3,4-epoxy-6-methylcyclohexylmethyl) adipate; bis(3,4-epoxycyclohexyl) adipate (available as ERL-4299 from The Dow Chemical Company, Midland, Mich.). In other embodiments, flexibilized epoxy resins may include (3′-4′-epoxycyclohexane)methyl 3′-4′-epoxycyclohexyl-carboxylate modified ξ-caprolactone (available as CELLOXIDE 2080 series from Daicel Chemical Industries, Ltd, Japan.)

Other flexibilized epoxy resins may include polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example.).

Other flexibilized epoxy resins may include glycidated resins, epoxidized oils, and so forth. The glycidated resins are frequently the reaction product of epichlorohydrin and a bisphenol compound, such as bisphenol A; C4 to C28 alkyl glycidyl ethers; C2 to C28 alkyl- and alkenyl-glycidyl esters; C1 to C28 alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene) phenol diglycidyl ether and (chloromethyl) oxirane Bisphenol A diglycidyl ether.

Still other epoxy-containing materials are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methylmethacrylate-glycidylacrylate and a 62.5:24:13.5 methylmethacrylate-ethyl acrylate-glycidylmethacrylate.

### Novolac Resins and Multifunctional Epoxy Resins

Epoxy phenolic novolac resins useful in embodiments disclosed herein may include condensates of phenols with formaldehyde that are obtained under acid conditions, such as phenol novolacs, bisphenol A novolacs, and cresol novolacs.

Suitable multi-functional (polyepoxy) compounds may include resorcinol diglycidyl ether (1,3-bis-(2,3-epoxypropoxy)benzene), triglycidyl p-aminophenol (4-(2,3-epoxypropoxy)-N,N-bis(2,3-epoxypropyl)aniline), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds.

Other suitable epoxy resins include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins may also include glycidyl derivatives of one or more of: aromatic diamines, aromatic monoprimary amines, aminophenols, polyhydric phenols, polyhydric alcohols, polycarboxylic acids.

Examples of epoxy phenolic novolac resins, epoxy bisphenol A novolac resins and multifunctional epoxy resins useful in various embodiments disclosed herein may include phenol-formaldehyde novolacs, such as those available under the tradenames D.E.N. 431 and D.E.N. 438 available from The Dow Chemical Company, Midland, Mich., and EPON SU-8, available from Hexion Specialty Chemicals.

### Bisphenol A and Bisphenol F Based Epoxy Resins

Other epoxy resins that may be used in various embodiments disclosed herein include 4,4′-dihydroxydiphenyl dimethyl methane (or bisphenol A), bis(4-hydroxyphenyl)methane (known as bisphenol F), diglycidyl ether of bromobisphenol A (2,2-bis(4-(2,3-epoxypropoxy)3-bromo-phenyl)propane), diglycidyl ether of Bisphenol F (2,2-bis(p-(2,3-epoxypropoxy)phenyl)methane), and other epoxy resins based on bisphenol A and bisphenol F. Bisphenol-A based epoxy resins may include, for example, diglycidyl ethers of bisphenol A; D.E.R.332, D.E.R. 383, and D.E.R. 331 from The Dow Chemical Company, Midland, Mich. Bisphenol-F based epoxy resins may include, for example, diglycidyl ethers of bisphenol-F, as well as D.E.R. 354 and D.E.R. 354LV, each available from The Dow Chemical Company, Midland, Mich.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; di- or polyglycidyl ethers of polyhydric alcohols such as 1,4-butanediol, or polyalkylene glycols such as polypropylene glycol, polyhydric phenols include resorcinol, 2,2-bis(4′-hydroxy-3′,5′-dibromophenyl)propane, 1,1,2,2-tetrakis(4′-hydroxy-phenyl)ethane, polyglycidyl ethers of aliphatic and aromatic polycarboxylic acids, such as, for example, oxalic acid, succinic acid, glutaric acid, terephthalic acid, 2,6-naphthalene dicarboxylic acid, and dimerized linoleic acid; polyglycidyl ethers of polyphenols, such as, for example, 1,1-bis(4-hydroxyphenyl)ethane, 1,1-bis(4-hydroxyphenyl)isobutane, and 1,5-dihydroxy naphthalene; modified epoxy resins with acrylate or urethane moieties; glycidylamine epoxy resins; and novolac resins.

Various trademarked epoxy resins based on bisphenol A diglycidyl (BADGE) ether are EPON® resin series, D.E.R® series, Epotuff® series, Araldite® series, EPI-Rez® series, and the ERL Bakelite® epoxy series

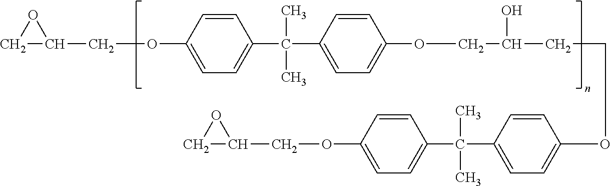

### Polyglycidyl Ethers of Phenolic Novolacs and Polyglycidyl Ethers of Cresolic Novolacs

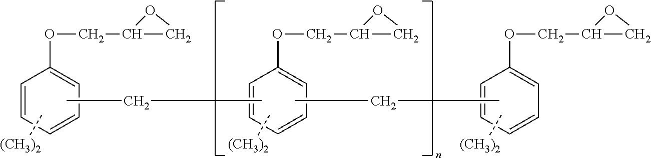

### Aromatic Glycidyl Amines

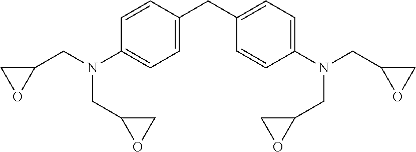 [SMILES: c1cc(N(CC2CO2)CC2CO2)ccc1Cc1ccc(N(CC2CO2)CC2CO2)cc1]

### Anhydride Cross-Linker

Curable compositions disclosed herein may include one or more cycloaliphatic anhydride cross-linkers. Cycloaliphatic anhydride cross-linkers may include, for example, nadic methyl anhydride, hexahydrophthalic anhydride, trimellitic anhydride, dodecenyl succinic anhydride, phthalic anhydride, methyl hexahydrophthalic anhydride, tetrahydrophthalic anhydride, and methyl tetrahydrophthalic anhydride, among others.

Most commercially available acid anhydride that is easy to process and cost efficient. The samples may include:

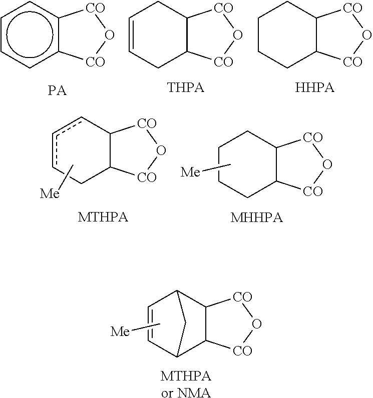

### Additional Epoxy Resins

Additional epoxy resins may be used to tailor the properties of the resulting thermoset resins as desired. The additional epoxy resin component may be any type of epoxy resin, including any material containing one or more reactive oxirane groups, referred to herein as “epoxy groups” or “epoxy functionality.” Additional epoxy resins useful in embodiments disclosed herein may include mono-functional epoxy resins, multi- or poly-functional epoxy resins, and combinations thereof. Monomeric and polymeric epoxy resins may be aliphatic, aromatic, or heterocyclic epoxy resins. The epoxies may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

### Additional Cross-Linkers/Curing Agents

In addition to the dicyandiamide cross-linkers described above, additional cross-linkers or curing agents may also be provided for promoting crosslinking of the epoxy resin composition to form a polymer composition. As with the epoxy resins, the additional cross-linkers and curing agents may be used individually or as a mixture of two or more. The curing agent component (also referred to as a cross-linker or cross-linking agent) may include any compound having an active group being reactive with the epoxy group of the epoxy resin. The curing agents may include nitrogen-containing compounds such as amines and their derivatives; oxygen-containing compounds such as carboxylic acid terminated polyesters, anhydrides, phenol novolacs, bisphenol-A novolacs, DCPD-phenol condensation products, brominated phenolic oligomers, amino-formaldehyde condensation products, phenol, bisphenol A and cresol novolacs, phenolic-terminated epoxy resins; sulfur-containing compounds such as polysulfides, polymercaptans; and catalytic curing agents such tertiary amines, Lewis acids, Lewis bases and combinations of two or more of the above curing agents. Practically, polyamines, diaminodiphenylsulfone and their isomers, aminobenzoates, various acid anhydrides, phenol-novolac resins and cresol-novolac resins, for example, may be used, but the present disclosure is not restricted to the use of these compounds.

Other components that may be useful in the compositions disclosed herein include curing catalysts. Examples of curing catalyst include imidazole derivatives, tertiary amines, ammonium salts, phosphonium salts, and organic metallic salts. Other examples of such curing catalysts include free radical initiators, such as azo compounds including azoisobutyronitrile, and organic peroxides, such as tertiary-butyl perbenzoate, tertiary-butyl peroctoate, and benzoyl peroxide; methyl ethyl ketone peroxide, acetoacetic peroxide, cumene hydroperoxide, cyclohexanone hydroperoxide, dicumyl peroxide, and mixtures thereof. Methyl ethyl ketone peroxide and benzoyl peroxide are preferably used in the present invention.

In some embodiments, curing agents may include primary and secondary polyamines and their adducts, anhydrides, and polyamides. For example, polyfunctional amines may include aliphatic amine compounds such as diethylene triamine (D.E.H. 20, available from The Dow Chemical Company, Midland, Mich.), triethylene tetramine (D.E.H. 24, available from The Dow Chemical Company, Midland, Mich.), tetraethylene pentamine (D.E.H. 26, available from The Dow Chemical Company, Midland, Mich.), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, may also be used.

In some embodiments, the phenol novolac cross-linker may contain a biphenyl or naphthyl moiety. The phenolic hydroxy groups may be attached to the biphenyl or naphthyl moiety of the compound.

In other embodiments, curing agents may include boron trifluoride monoethylamine, and diaminocyclohexane. Curing agents may also include imidazoles, their salts, and adducts. These epoxy curing agents are typically solid at room temperature.

The foregoing disclosure and description of the invention is illustrative and explanatory thereof. Various changes in the details of the illustrated structures, construction and method can be made without departing from the true spirit of the invention.

We claim:

1. A composite liner inside a steel tube comprising:
a glass-reinforced epoxy resin system forming the composite liner attached to the inner diameter of the steel tube; and
an anti-corrosion coating or plating on an inner diameter of the steel tubes with low gas permeability serving as a more effective barrier than a grout layer and enhancing performance, wherein the anti-corrosive coating or plating is sandwiched between the glass-reinforced epoxy resin system and the steel tube.

2. The composite liner of claim 1, wherein the anti-corrosion coating or metal plating used in the composite liner has a thickness ranging between about 2 to about 10 mills in thickness.

3. The composite liner of claim 1, wherein the glass-reinforced epoxy resin system is about 2 to 4 mm thick.

4. The composite liner of claim 1, wherein the plating is a metal plating, which is at least one of Ni—P or Ni—W plating system.

5. The composite liner of claim 1, wherein the anti-corrosion coating comprises a polymer coating.

6. The composite liner of claim 5, wherein the polymer coating comprises an epoxy coating.

7. A method of manufacturing a composite liner for a steel tube, comprising:
coating an inner diameter (ID) of the steel tube with an anti-corrosion coating or plating;
inserting a glass-reinforced epoxy composite liner into the steel tube; and
curing the glass-reinforced epoxy composite liner inside the steel tube.

8. The method of claim 7, wherein the glass-reinforced epoxy composite liner has an outer diameter larger than the inner diameter of the steel tube.

9. The method of claim 7, wherein the anti-corrosion coating or metal plating comprises a low gas permeability material.

10. The method of claim 9, wherein the anti-corrosion coating comprises a polymer coating.

11. The method of claim 9, wherein the anti-corrosion metal plating is at least one of Ni—P, or Ni—W coating.

12. The method of claim 9, wherein the curing stage involves precise control of curing temperature and time to cure resin within the liner to a lesser degree, retaining deformable characteristics.

13. The method of claim 9, wherein the glass-reinforced epoxy composite liner comprises a dual catalyst system.

14. The method of claim 13, wherein the dual catalyst system comprises a low temperature catalyst and a high temperature catalyst.

15. The method of claim 13, further comprising filament winding glass-reinforced epoxy on a mandrel.

16. A composite liner for a steel tube comprising:
a resin system directly affixed to an inner diameter of a steel tube without requiring a troublesome grout layer, thereby eliminating a need for costly and less dependable grout layers; and
a thin coating or metal plating measuring between 2 to 10 mills in thickness, wherein the thin coating or metal plating is sandwiched between the glass-reinforced epoxy resin system and the inner diameter of the steel tube.

17. The composite liner of claim 16, wherein the resin system comprises glass-reinforced epoxy.

18. The composite liner of claim 17, wherein the glass-reinforced epoxy resin system is about 2 to 4 mm thick.

19. The composite liner of claim 16, wherein the metal plating is at least one of Ni—P or Ni—W plating system.

20. The composite liner of claim 16, wherein the thin coating comprises an epoxy coating.
